(19) United States
(12) Patent Application Publication
(10) Pub. No.: US 2012/0060752 A1
(43) Pub. Date: Mar. 15, 2012

(54) APPARATUS FOR FORMING SILICON OXIDE FILM

(75) Inventors: Masahiro KIYOTOSHI, Yokkaichi (JP); Shigeki Sugimoto, Yokkaichi (JP)

(73) Assignee: Kabushiki Kaisha Toshiba, Tokyo (JP)

(21) Appl. No.: 13/049,456

(22) Filed: Mar. 16, 2011

(30) Foreign Application Priority Data
Sep. 10, 2010 (JP) 2010-203040

(51) Int. Cl. B05C 9/12; B05C 9/02; B05C 11/00; B05C 13/00; B05C 11/02

(52) U.S. Cl. 118/52

(57) ABSTRACT

An apparatus for forming silicon oxide film is disclosed. The apparatus includes a spin coating unit, a carrying unit, and an oxidation unit. The spin coating unit forms a polymer film above a substrate by spin coating a solution including a polymer containing a silazane bond dissolved in an organic solvent. The carrying unit carries the substrate to the oxidation unit without contacting the polymer film. The oxidation unit, when receiving the substrate from the carrying unit, converts the polymer film into the silicon oxide film by either immersing the polymer film with a heated aqueous solution containing hydrogen peroxide, spraying the heated aqueous solution containing hydrogen peroxide over the polymer film, or exposing the polymer film to a reaction gas containing a hydrogen peroxide vapor. The apparatus, by itself, completes the polymer film formation and the polymer-to-silicon oxide film conversion within the apparatus itself.

### CROSS-REFERENCE TO RELATED APPLICATION(S)

This application is based upon and claims the benefit of priority from Japanese Patent Application No. 2010-203040, filed on, Sep. 10, 2010 the entire contents of which are incorporated herein by reference.

### FIELD

Exemplary embodiments disclosed herein generally relate to an apparatus for forming a silicon oxide film.

### BACKGROUND

Semiconductor devices are being scaled down at accelerated pace to meet requirements to run faster with less electricity consumption and cost. Such scaling is typically driven by shrunk transistor and interconnect dimensions. However, with advances in microfabrication for forming smaller transistors and finer interconnects, some steps of the manufacturing process flow have become significantly challenging. One of such examples is formation of element isolation regions for providing insulation between densely packed elements, typically transistors, which requires filling of insulation film with favorable insulativity into micro-spaces/gaps.

SOG (Spin On Glass) coating techniques employing perhydro-polysilazane coating has found application in filling such narrow element isolation regions. Perhydro-polysilazane film, however, is an inorganic compound having a molecule structure of (SiH₂—NH)ₙ and needed to be thermally treated in an oxidative steam-rich atmosphere at a high temperature of at least 220 degrees Celsius for conversion into a silicon oxide film.

However, as device elements become scaled down, it is becoming increasingly challenging to form high-quality insulating film in limited spaces. This is, in part, due to the difficulty in performing thermal treatments in oxidative steam-rich atmosphere without adversely affecting the feature characteristics and because of the requirements for further lower process temperature.

### BRIEF DESCRIPTION OF THE DRAWINGS

FIG. 1 is a plan view of an inner structure of an apparatus according to a first exemplary embodiment of the present disclosure;

FIG. 2A is a perspective view of a carrying unit schematically illustrating the structural elements for holding a substrate and how the substrate is carried by such elements;

FIG. 2B is a partial cross sectional view of the carrying unit featuring a portion of the carrying unit placed in contact with the bevel of the substrate when the substrate is carried by the carrying unit;

FIG. 3 is a vertical cross sectional view illustrating the structural elements of an oxidation unit according to the first exemplary embodiment;

FIG. 4 is a plan view of a modified inner structure of the apparatus;

FIG. 5 schematically illustrates the structures of an isothermal plate and a temperature control mechanism;

FIGS. 6A and 6B are comparative charts collectively indicating process sequences of EXAMPLES discussed in the first exemplary embodiment and the characteristics of films obtained by such process sequences;

FIG. 7A illustrates a second exemplary embodiment of the present disclosure and corresponds to FIG. 2A;

FIG. 7B illustrates the second exemplary embodiment and corresponds to FIG. 2B;

FIG. 8 illustrates a third exemplary embodiment of the present disclosure and corresponds to FIG. 1;

FIG. 9 illustrates the third exemplary embodiment and corresponds to FIG. 3;

FIG. 10 illustrates the structural elements of a vaporizer according to the third exemplary embodiment; and

FIGS. 11A and 11B are comparative charts collectively indicating process sequences of EXAMPLES discussed in the third exemplary embodiment and the characteristics of films obtained by such process sequences.

### DETAILED DESCRIPTION

In one exemplary embodiment, an apparatus for forming silicon oxide film is disclosed. The apparatus includes a spin coating unit, a carrier unit, and an oxidation unit. The spin coating unit forms a polymer film above a substrate by spin coating a solution including a polymer containing a silazane bond dissolved in an organic solvent. The carrying unit carries the substrate having the polymer film formed thereabove by the spin coating unit to the oxidation unit without contacting the polymer film. The oxidation unit, when receiving the substrate from the carrying unit, converts the polymer film into the silicon oxide film by either immersing the polymer film with a heated aqueous solution containing hydrogen peroxide, spraying the heated aqueous solution containing hydrogen peroxide over the polymer film, or exposing the polymer film to a reaction gas containing a hydrogen peroxide vapor. The apparatus, by itself, completes the formation of the polymer film by the spin coating unit and the conversion of the polymer film into the silicon oxide film by the oxidation unit within the apparatus itself.

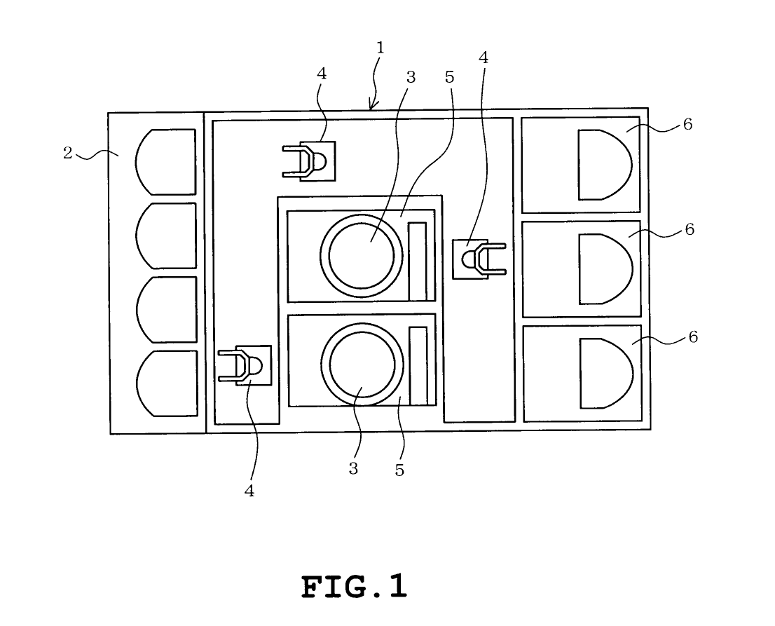

A first exemplary embodiment of the present disclosure is described hereinafter with reference to FIGS. 1 to 6B. Apparatus for forming silicon oxide film 1, which may also be simply referred to as apparatus 1 herein, immerses perhydro-polysilazane polymer film with an aqueous hydrogen peroxide solution for conversion into a silicon oxide film.

Apparatus 1 processes a prefabricated substrate (wafer) 3, typically a semiconductor substrate such as a silicon substrate, with element isolation trenches formed into it using an STI (Shallow Trench Isolation) scheme. The element isolation trenches are formed on the order of several tens of nanometers (nm) to isolate the active areas of substrate 3. The element to be formed in the active area is typically a transistor. Apparatus 1 fills the narrow trenches with a liquid coating film and converts the coating film into a silicon oxide film to obtain element isolation trenches filled with an insulating film. Apparatus 1 is thus, adapted for manufacturing a semiconductor device with isolated active regions.

FIG. 1 is a plan view of the inner structure of apparatus 1. As can be seen in FIG. 1, apparatus 1 is primarily configured by load port 2, carrying unit 4, spin coating unit 5, and oxidation unit 6 located at their designated places within a single apparatus housing to allow the formation of silicon oxide film to be completed within apparatus 1. Apparatus 1 resembles the structure of a coating apparatus for providing resist or SOG coating.

Load port 2 of apparatus 1 receives FOUP (Front Opening Unified Pod) which is loaded with one or more substrates 3. Substrate 3 is carried from FOUP to spin coating unit 5 by carrying unit 4.

Spin coating unit 5 forms perhydro-polysilazane polymer film 3b in a given thickness above substrate 3 by spin coating a perhydro-polysilazane polymer solution over substrate 3. Perhydro-polysilazane polymer solution is prepared by dissolving perhydro-polysilazane containing a silazane bond into an organic solvent. Perhydro-polysilazane polymer solution may be referred as polymer solution, and the resulting perhydro-polysilazane polymer film 3b may be referred as polymer film 3b hereinafter for simplicity. The thickness of the coated polymer film 3b may be controlled through adjustment in spin speed and concentration of the polymer solution.

Carrying unit 4 carries the polymer-film-coated substrate 3 to oxidation unit 6. In doing so, the first exemplary embodiment is arranged such that carrying unit 4 does not contact polymer film 3b at any point as will be later described. Such arrangement is important especially because polymer film 3b remains soft and unstable in the first exemplary embodiment in the absence of soft baking which is typically carried out at the temperature of 150 degrees Celsius or greater.

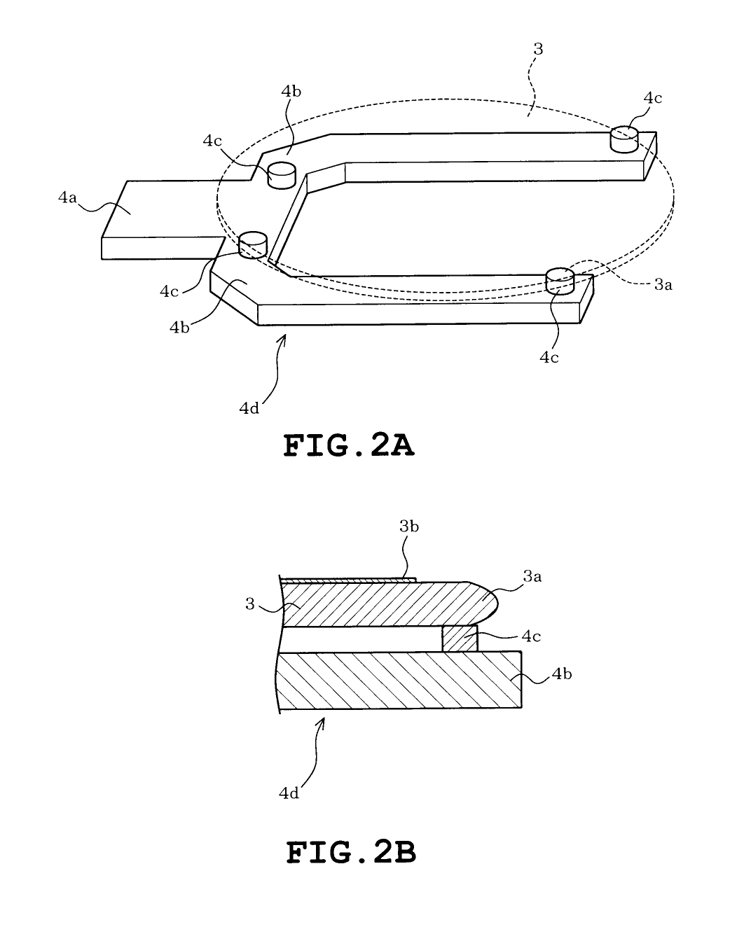

FIGS. 2A and 2B illustrate the structural elements of carrying unit 4 that hold substrate 3. FIG. 2A is a perspective view schematically describing how substrate 3 is held by carrying unit 4, whereas FIG. 2B is a schematic cross sectional view of the interface between the bevel of substrate 3 and carrying unit 4.

As can be seen in FIG. 2A, carrying unit 4 includes base end 4a, lateral arm 4b, and support pins 4c. Base end 4a is a receiving end of the force for driving carrying unit 4. Lateral arm 4b branches off laterally from base end 4a into a plurality of arms. The first exemplary embodiment employs a configuration in which base end 4a is bifurcated into two arms. Lateral arm 4b has a pair of left and right prongs 4d that extend substantially parallel to the longer side direction of base end 4a as viewed in FIG. 2A. Support pins 4c are provided on the upper surface of lateral arm 4b. FIG. 2A exemplifies a configuration in which a couple of support pins 4c formed near base end 4a and a couple of support pins 4c formed near the tips of prongs 4d. Lateral arm 4b is dimensioned substantially in the same size as substrate 3.

When substrate 3 is placed on carrying unit 4, support pins 4c formed on top of lateral arm 4b receive bevel 3a of substrate 3 which is the only point of contact between substrate 3 and carrying unit 4.

As shown in FIG. 2B, because 1 to 3[m] from the substrate edge of polymer film 3b is removed before substrate 3 is placed on carrying unit 4, there is no risk of contact between polymer film 3b and support pins 4c even if bevel 3a is placed on support pins 4c. Carrying unit 4 keeps the upper surface of substrate 3 level while carrying it from spin coating unit 5 to oxidation unit 6.

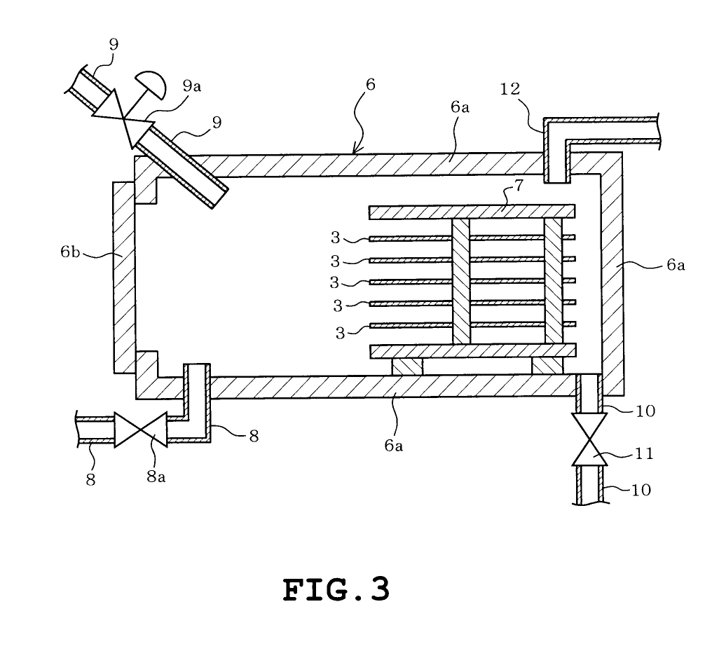

FIG. 3 schematically illustrates a vertical cross section of oxidation unit 6. Oxidation unit 6 immerses polymer film 3b with an aqueous hydrogen peroxide solution.

Inner wall 6a surface of oxidation unit 6 is fully coated by fluorine based resin. Alternatively, inner wall 6a surface of oxidation unit 6 may be resin molded. Inner wall 6a surface of oxidation unit 6 is kept at a predetermined temperature level of, for instance, 80 degrees Celsius. Such temperature control may be rendered by providing a heater or by circulating heat medium within the walls.

Oxidation unit 6 is accessed through a forward opening which is enclosed by door 6b. Door 6b is opened as polymer-film-coated substrate 3 is carried into oxidation unit 6 and is closed after substrate 3 is installed into holder 7. FIG. 3 exemplifies holder 7 taking a shelf configuration having a capacity of stacking five horizontally leveled substrates 3 with vertical spacing between substrates 3.

At the lower portion of oxidation unit 6, inlet 8 is provided for supplying chemicals and serves as hydrogen peroxide supplier/rinse liquid supplier in the first exemplary embodiment. Inlet 8 is provided with check valve 8a for opening/closing passageway for liquid flow such as chemicals. At the upper portion of oxidation unit 6, inlet 9 is provided for supplying purge gas. Inlet 9 is provided with check valve 9a for opening/closing passageway for gas flow. Provided further at the lower portion of oxidation unit 6 is drain 10 serving as a drain mechanism provided for collecting waste water produced when processing substrate 3. Drain 10 is also provided with check valve 11 for opening/closing passageway for drainage. By opening check valve 11 after processing substrate 3, residues within oxidation unit 6 can be discharged from drain 10. Provided further at the upper portion of oxidation unit 6 is exhaust duct 12 for discharging exhaust gas.

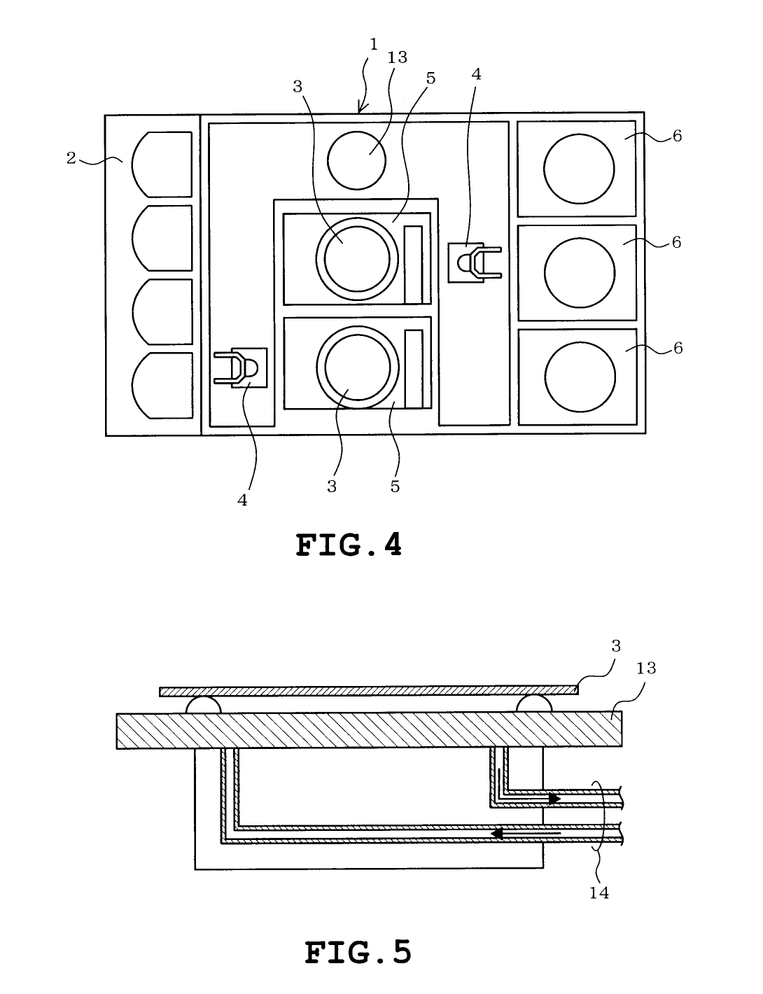

Carrying unit 4, carrying substrate 3 from load port 2 to spin coating unit 5, may be arranged to stop by at an isothermal plate 13 provided within apparatus 1 as shown in a modified exemplary embodiment of FIG. 4. In operation, carrying unit 4, after approaching isothermal plate 13, may place substrate 3 onto isothermal plate 13 and control the temperature of substrate 3 at a predetermined temperature level by temperature control mechanism such as a chiller.

FIG. 5 is a cross sectional view schematically illustrating the structure and the working of isothermal plate 13 and temperature control mechanism 14. As shown, temperature control mechanism 14 circulates heat medium to and from isothermal plate 13 to stabilize the temperature of substrate 3 at a predetermined level. By stabilizing the temperature of substrate 3, polymer film 3b can be formed with greater uniformity and repeatability.

Apparatus 1 according to the first exemplary embodiment handles variety of processes within a single machine housing and thus, is capable of obtaining the required silicon oxide film by itself in relatively less number of apparatuses and in less number of process steps as compared to conventional process sequences. Further, the silicon oxide film obtained by apparatus 1 contains relatively less impurity concentration, less amount of film shrinkage, and less interfacial fixed charge density as compared to conventional process sequences.

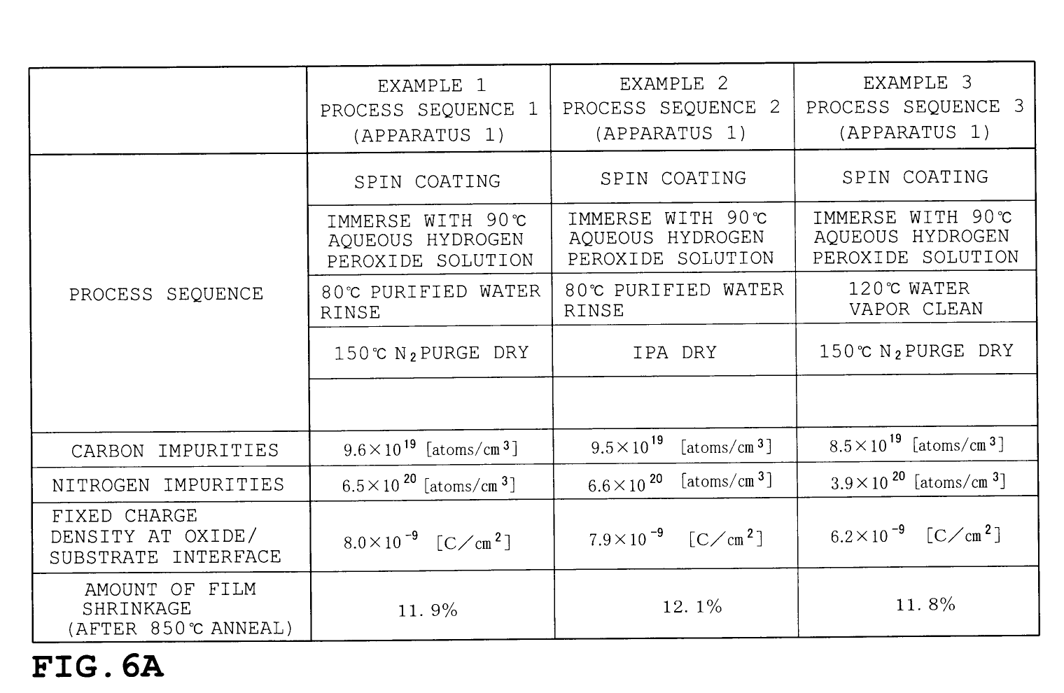

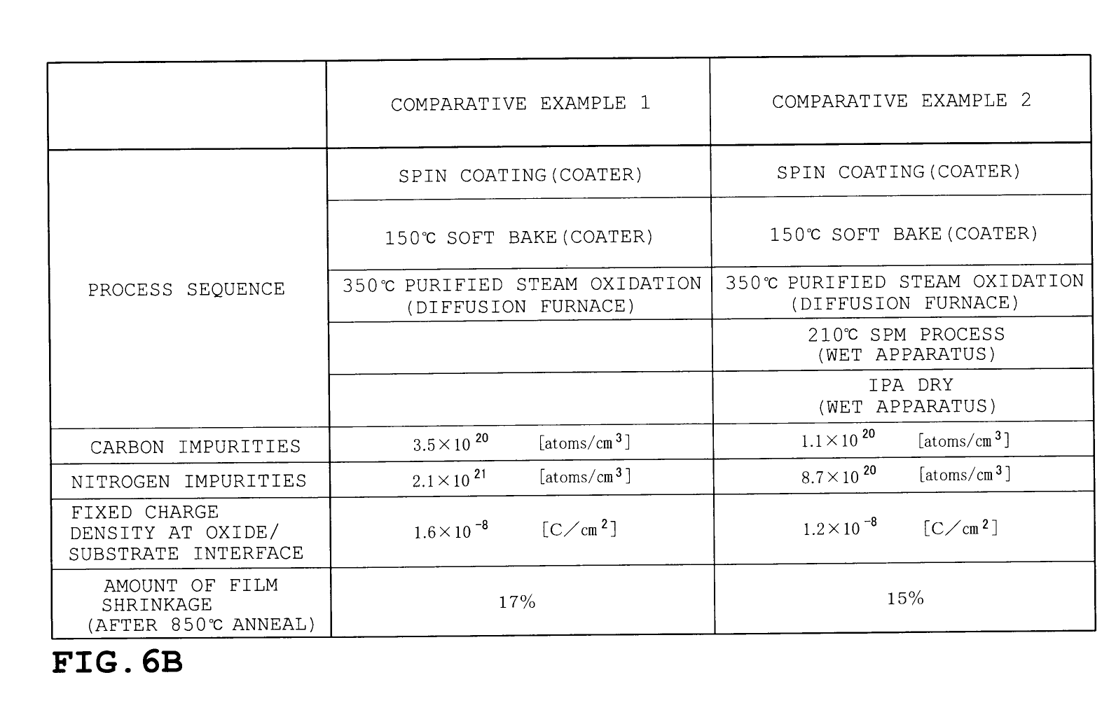

Examples of process sequences carried out by apparatus 1 configured as described above will be discussed based on the charts shown in FIGS. 6A and 6B.

### Example 1

Polymer film 3b was formed by the following series of processes. Perhydro-polysilazane polymer [(SiH₂—NH)ₙ] having an average molecular weight ranging between 1500 to 5500 was dissolved in an organic solvent such as xylene or dibutyl ether to obtain a polymer solution. The polymer solution was dripped onto the center of substrate 3 spun steadily at 1000 [rpm] for two seconds, after 5 seconds of acceleration, at the drip rate of 1[cc/min] to uniformly coat the polymer solution entirely above substrate 3. Then, substrate 3 was spun for 20 more seconds to evaporate the solvent contained in the polymer solution to obtain an flat polymer film 3b.

Polymer film 3b coated above bevel 3a of substrate 3 often peel off and cause dust issue when placed in contact with the components of substrate carriers and thus, is removed in appropriate amounts, for instance, by thinners.

Polymer film 3b, thus coated, contains some but less than 20% of impurities such as carbon and hydrocarbon originating from the solvent as well as several tens of percent of nitrogen originating from perhydro-polysilazane polymer. These impurities are removed to convert polymer film 3b into a silicon oxide film.

Polymer-film-coated substrate 3 was carried from spin coating unit 5 into oxidation unit 6 by carrying unit 4 to be placed on holder 7. Then, check valve 11 was closed and 30 weight % (wt %) of aqueous hydrogen peroxide solution heated to 90 degrees Celsius was supplied into oxidation unit 6 through inlet 8. The aqueous hydrogen peroxide solution is typically supplied at the speed of 20 [slm]. Substrate 3 is thus, immersed with 30 wt % of aqueous hydrogen peroxide solution.

In EXAMPLE 1, substrate 3 was immersed in aqueous hydrogen peroxide solution for 15 minutes. Then, while supplying purified water warmed to 80 degrees Celsius serving as rinse liquid from inlet 8, check valve 11 was opened to discharge waste water from drain 10 and to substitute aqueous hydrogen peroxide solution within oxidation unit 6 with purified water. This substitution to purified water was executed for 5 minutes. Then, supplying of purified water was stopped and substrate 3 was dried by supplying hot nitrogen (N₂) heated to 150 degrees Celsius through inlet 9 while keeping check valve 11 opened.

It was verified that by incorporating the above described series of steps, diffusion of impurities such as carbon and nitrogen toward substrate 3 can be suppressed during the process of converting polymer 3b into silicon oxide film.

More specifically, because the above described steps are carried out under relatively low temperature with the maximum process temperature level being 150 degrees Celsius, impurities such as carbon and hydrocarbon originating from the solvent can be reduced to a concentration below 10²⁰ [atoms/cc] while preventing their diffusion toward the interface between the resulting silicon oxide film and substrate 3, and concentration of nitrogen originating from perhydro-polysilazane polymer can be reduced to a concentration below 10²¹ [atoms/cc].

The silicon oxide film is filled in the element isolation region that isolates the active regions of substrate 3 by an STI scheme. Thus, accumulation of fixed charge at the interface between the element isolation region and substrate 3 will affect the electric properties of the feature. However, it was verified that the generation of fixed charge at the interface between the element isolation region and substrate 3 can be suppressed by incorporating the above described steps.

### Example 2

EXAMPLE 2 differs from EXAMPLE 1 in that substrate 3 is dried by IPA (Isopropyl Alcohol) instead of hot nitrogen (N₂) employed in EXAMPLE 1. It was verified in EXAMPLE 2 as well that concentration of impurities such as carbon and hydrocarbon can be reduced to below 10²⁰ [atoms/cc] and concentration of nitrogen originating from perhydro-polysilazane polymer can be reduced below 10²¹ [atoms/cc].

### Example 3

EXAMPLE 3 differs from EXAMPLE 1 in that water rinse executed with purified water warmed to 80 degrees Celsius in EXAMPLE 1 was replaced by vapor rinse executed with purified steam at 120 degrees Celsius. It was verified in EXAMPLE 3 as well that concentration of impurities such as carbon and hydrocarbon can be reduced below 10²⁰ [atoms/cc] and concentration of nitrogen originating from perhydro-polysilazane polymer can be reduced below 10²¹ [atoms/cc].

FIGS. 6A and 6B taken together provide a comparative chart of the process sequences executed in EXAMPLES 1 to 3 and the features of the resulting film which are evaluated by (1) carbon impurity concentration, (2) nitrogen impurity concentration, (3) fixed charge density, and (4) amount of film shrinkage after thermal treatment executed in inert gas atmosphere at 850 degrees Celsius.

FIG. 6B indicates COMPARATIVE EXAMPLE 1 in which polymer film 3b being formed above substrate 3 is converted into a silicon oxide film through thermal oxidation lasting 30 minutes in a 75% steam atmosphere of 350 degrees Celsius using a diffusion furnace. COMPARATIVE EXAMPLE 2 also shown in the chart of FIG. 6B performs a wet oxidation process in addition to the process sequence of COMPARATIVE EXAMPLE 1. The wet oxidation process is carried out in a high temperature SPM (Sulfuric Peroxide Mixture) of, for instance, 210 degrees Celsius. The amount of film shrinkage is an index for evaluating the propensity of defects such as delamination from substrate 3 and crack formation which affect advantageously indicates less risk of such defects.

As can be seen from FIGS. 6A and 6B, EXAMPLES 1 to 3 all favorably show relatively less impurity concentration, less amount of film shrinkage, and less fixed charge density as compared to COMPARATIVE EXAMPLES 1 and 2. Further, a comparison of EXAMPLES 2 and 3 shows that nitrogen impurity is more effectively suppressed in the steam rinse using hot purified water as compared to the water rinse using warm purified water.

Still further, because spin coating in COMPARATIVE EXAMPLE 2 is followed by a sequence of soft bake, steam oxidation, wet oxidation in high-temperature SPM, and IPA dry, the process sequence requires separate installations of at least 3 types of apparatuses namely, a spin coater, a diffusion furnace, and a wet process apparatus. Similarly, because spin coating in COMPARATIVE EXAMPLE 1 is followed by soft bake and steam oxidation, the process sequence requires at least 2 types of apparatuses namely, a spin coater and a diffusion furnace.

According to EXAMPLES 1 to 3, formation of silicon oxide film can be completed within a single machine housing of apparatus 1.

Because EXAMPLES 1 to 3 do not involve soft bake during perhydro-polysilazane coating, the resulting polymer film 3b does not harden sufficiently. This leaves room for defects such as peeling and particle generation or damaging of polymer film 3b as the result of contact between polymer film 3b and the components of FOUP in case that the polymer-film-coated substrates 3 are carried by FOUP. In the first exemplary embodiment, however, the conversion of polymer film 3b into silicon oxide film is carried out within a single machine housing of apparatus 1 and therefore need not be carried from one apparatus to another by FOUP during the process of conversion. Thus, the first exemplary embodiment is free of aforementioned defects.

Further, the maximum process temperature can be relatively reduced compared to the conventional process sequences as mentioned earlier and sublimation of low-molecular weight perhydro-polysilazane polymer components can be almost completely eliminated.

In the first exemplary embodiment, low molecular weight perhydro-polysilazane components may be intentionally introduced into polymer film 3b to fill the narrow trenches with outstanding gap-fill capability. Low-molecular weight components within perhydro-polysilazane, however, easily sublime, meaning that sublimation occurs at a relatively low temperature zone. Thus, process sequences such as those of COMPARATIVE EXAMPLES 1 and 2 involving thermal treatments such as soft bake at the temperature level of 150 degrees Celsius using the spin coater and thermal recovery at the temperature level of 350 degrees Celsius have been found to suffer loss of low-molecular weight perhydro-polysilazane components by sublimation.

Loss of low-molecular weight perhydro-polysilazane components is also caused by evaporation which occurs significantly under reduced pressure. However, because apparatus 1 executes the process sequence up to oxidation under atmospheric pressure, it does not suffer evaporation of low-molecular weight components due to pressure reduction.

The first exemplary embodiment converts polymer film 3b formed above substrate 3 into silicon oxide film by immersing polymer film 3b with high-temperature aqueous hydrogen peroxide solution. Alternatively, heated aqueous hydrogen peroxide solution may be gas atomized through mixture with gases such as a carrier gas containing hot steam and be sprayed over substrate 3 through inlet 8. This alternative approach obtains almost the same level of polymer-to-silicon oxide conversion as the immersion approach with relatively less amount of hydrogen peroxide. The carrier gas used in such case may be either of oxygen, nitrogen, and argon, etc.

According to the first exemplary embodiment, apparatus 1 for forming a silicon oxide film includes spin coating unit 5 and oxidation unit 6. Spin coating unit 5 forms polymer film 3b above substrate 3 by dissolving a polymer including a silazane bond into organic solvent and spin coating the resulting solution over substrate 3. The obtained polymer film 3b is immersed with aqueous hydrogen peroxide solution controlled at the temperature level ranging between 70 degrees Celsius and 100 degrees Celsius to be converted into a silicon oxide film.

The above described process sequence is executed under relatively lower process temperature level, which is 150 degrees Celsius at maximum in EXAMPLES 1 to 3. Thus, impurities originating from polymer film 3b can be removed and diffusion of such impurities into the underlying substrate 3 can be completely eliminated while effectively suppressing film shrinkage caused by sublimation of low-molecular weight polymer components. Further, because the maximum process temperature is limited to 150 degrees Celsius, the conversion of polymer film 3b into silicon oxide film can also be carried out under such low temperature level, thereby minimizing side effects that deteriorates device properties such as bird's beak oxidation formation.

Oxidation unit 6 of the first exemplary embodiment is also capable of executing the rinse process with hot steam instead of warm purified water. More specifically, the warm purified water is vaporized by introducing carrier gas such as a hot nitrogen gas (N₂) through inlet 8. The use of such hot steam advantageously reduces the duration of the rinse process.

Apparatus 1 of the first exemplary embodiment fills the trenches formed into substrate 3 with polymer film 3b made of polymer solution using a spin coating technique. Thus, outstanding uniform gap-fill can be realized even when filling narrow trenches on the order of tens of nanometers. The uniformity of the gap-fill is within a margin of ±2% even when processing over 300 mm substrates. Further, because the entire process sequence occurs under relatively low temperature level, a silicon oxide film with outstanding gap-fill capability can be obtained under low process temperature to yield a high-performance electronic device free of thermal side effects.

According to the first exemplary embodiment, a high-quality oxide film containing relatively less impurities can be obtained from silazane-bond-containing polymer film 3b without having to execute high temperature annealing. The elimination of high temperature annealing prevents oxidation/thermal deterioration of the underlying device features.

Apparatus 1 undertakes the process sequence ranging from polymer film 3b coating to silicon oxide film conversion by itself. In the first exemplary embodiment, the process sequence includes immersing polymer film 3b into aqueous hydrogen peroxide solution, draining of residual aqueous hydrogen peroxide solution, rinsing, and drying. Thus, the process sequence according to the first exemplary embodiment can be executed with relatively less number of apparatuses and process steps compared to conventional process sequences.

Hydrogen peroxide reacts strongly with metal and is highly toxic. Thus, desirably, treatment involving hydrogen peroxide should be handled with a minimized risk of exposure to the human body. To this end, the first exemplary embodiment completes treatment involving hydrogen peroxide within apparatus 1 by heating polymer film 3b with heated aqueous hydrogen peroxide solution. This eliminates the need for an additional mechanism for heating substrate 3 and thus is more efficient and safer.

Further, waste water containing hydrogen peroxide residue is discharged from the drain mechanism exemplified as drain 10 during the purified water rinse step. This allows the safety mechanism of the wet clean feature to be utilized, thereby reducing the number of apparatuses as compared to the conventional process sequences as well as improving safety.

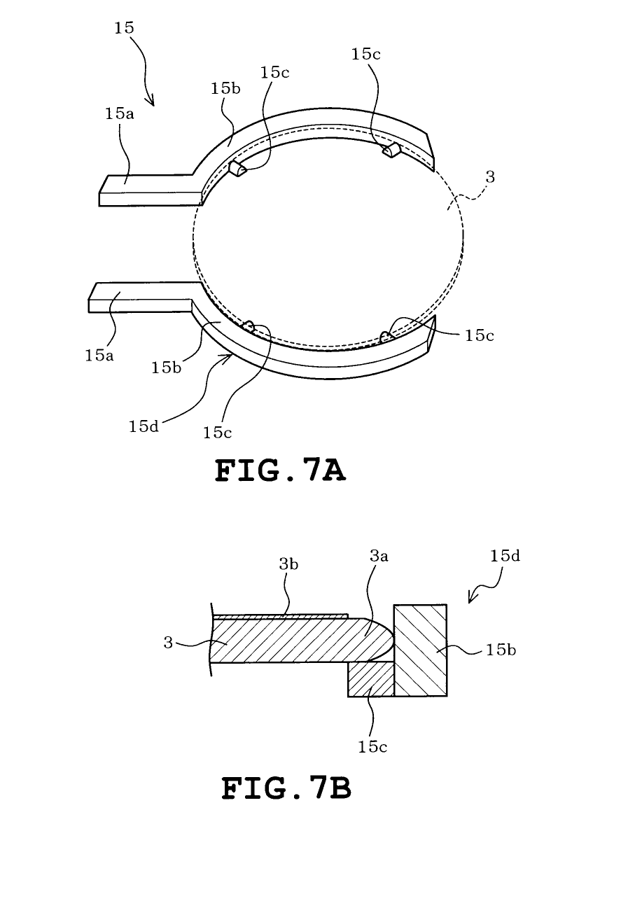

FIGS. 7A and 7B illustrate a second exemplary embodiment of the present disclosure which differs from the first exemplary embodiment in the structure of arms of the carrying unit used to carry substrate 3. Elements that are identical or similar to the first exemplary embodiment are identified with identical reference symbols and are not redescribed. The descriptions given hereinafter are primarily directed to the differences from the first exemplary embodiment.

As mentioned in the first exemplary embodiment, unbaked polymer film 3b is soft and is structurally unstable. Thus, substrate 3 must be carefully carried such that nothing in the apparatus 1 contacts polymer film 3b to prevent damages or delamination of polymer film 3b.

FIGS. 7A and 7B illustrate the main portions of carrying unit 15 according to the second exemplary embodiment which has alternative features to those of carrying unit 4 of the first exemplary embodiment. FIG. 7A is a perspective view whereas FIG. 7B is a vertical cross sectional view. Carrying unit 15 is provided with arms 15b as a replacement to lateral arm 4b. FIG. 7A shows a pair of arms 15b and a plurality of support sections 15c. Arms 15b extend from base end 15a so as to surround the perimeter of substrate 3. Support sections 15c are provided on the inner perimeter surface of arm 15b so as to protrude radially inward.

FIG. 7B shows how substrate 3 is carried by carrying unit 15. As shown, support sections 15c support the underside bevel 3a of substrate 3 whereas arms 15b hold the side surface of substrate 3 such that upper surface of substrate 3 is level. Polymer film 3b formed above substrate 3 is removed by approximately 1 to 3 mm from the perimeter edge of substrate 3 and thus, is not adversely affected even when support section 15c contacts the periphery of bevel 3a of substrate 3.

Second exemplary embodiment thus, prevents contact between arms 15d of carrying unit 15 and polymer film 3b to provide the advantages similar to those of the first exemplary embodiment.

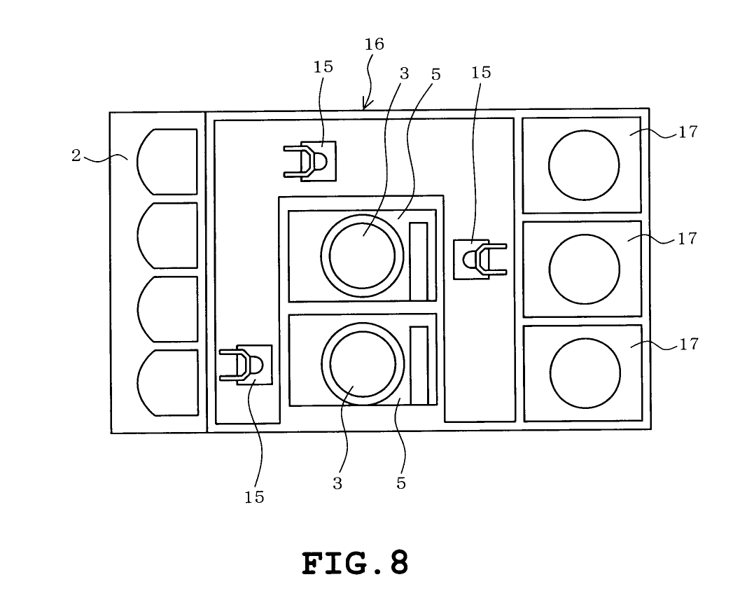

FIGS. 8 to 11B represent a third exemplary embodiment which differs from the first exemplary embodiment in that polymer film 3b is converted into silicon oxide film through exposure to vaporized hydrogen peroxide instead of the immersing and spraying of aqueous hydrogen peroxide solution discussed in the first exemplary embodiment. Elements that are identical or similar to the first exemplary embodiment are identified with identical reference symbols and are not redescribed. The descriptions given hereinafter are primarily directed to the differences from the first exemplary embodiment.

FIG. 8 schematically illustrates apparatus 16 according to the third exemplary embodiment which is an alternative configuration to apparatus 1 of the first exemplary embodiment. As shown, apparatus 16 is provided with carrying unit 15 discussed in the second exemplary embodiment which replaces carrying unit 4 of the first exemplary embodiment. Apparatus 16 is further provided with oxidation unit 17 which replaces oxidation unit 6 of the first exemplary embodiment.

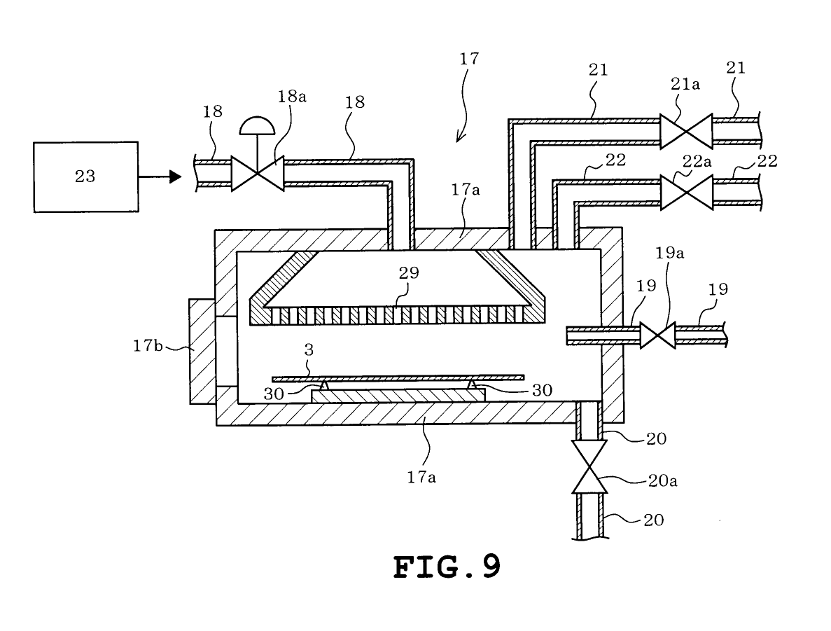

FIG. 9 is a vertical cross section of oxidation unit 17 and corresponds to FIG. 3.

Oxidation unit 17 exposes polymer film 3b to hydrogen peroxide vapor.

At the upper portion of oxidation unit 17, inlet 18 is provided for supplying chemicals and purified steam/vapor, and serves as hydrogen peroxide supplier and rinse liquid/vapor supplier in the third exemplary embodiment. At the side section of oxidation unit 17 as viewed in FIG. 9, inlet 19 is provided for supplying IPA for drying substrate 3. At the lower portion of oxidation unit 17, drain 20 is provided for collecting and discharging waste. Provided further at the upper portion of oxidation unit 17 is acid exhaust duct 21 and vacuum exhaust duct 22. Vacuum exhaust duct 22 is used in drying substrate 3 and is connected with organic duct for exhausting IPA.

Inlets 18 and 19, drain 20, acid exhaust duct 21, and vacuum exhaust duct 22 are provided with corresponding check valves 18a, 19a, 20a, 21a, and 22a. Oxidation unit 17 can be connected with either acid exhaust duct 21 or vacuum exhaust duct 22.

Inner wall 17a surface of oxidation unit 17 is fully coated by a fluorine based resin. Alternatively, inner wall 17a surface of oxidation unit 17 may be resin molded. Inner wall 17a of oxidation unit 17 is kept at a predetermined temperature level of, for instance, 120 degrees Celsius. Such temperature control may be rendered by providing a heater or circulating heat medium within the walls.

Inlet 18 connects with generator, exemplified as vaporizer 23, which generates hydrogen peroxide vapor from aqueous hydrogen peroxide solution. Content of aqueous hydrogen peroxide solution supplied to and vaporized at vaporizer 23 is typically 30 wt % and is flow controlled by liquid MFC (Mass Flow Controller).

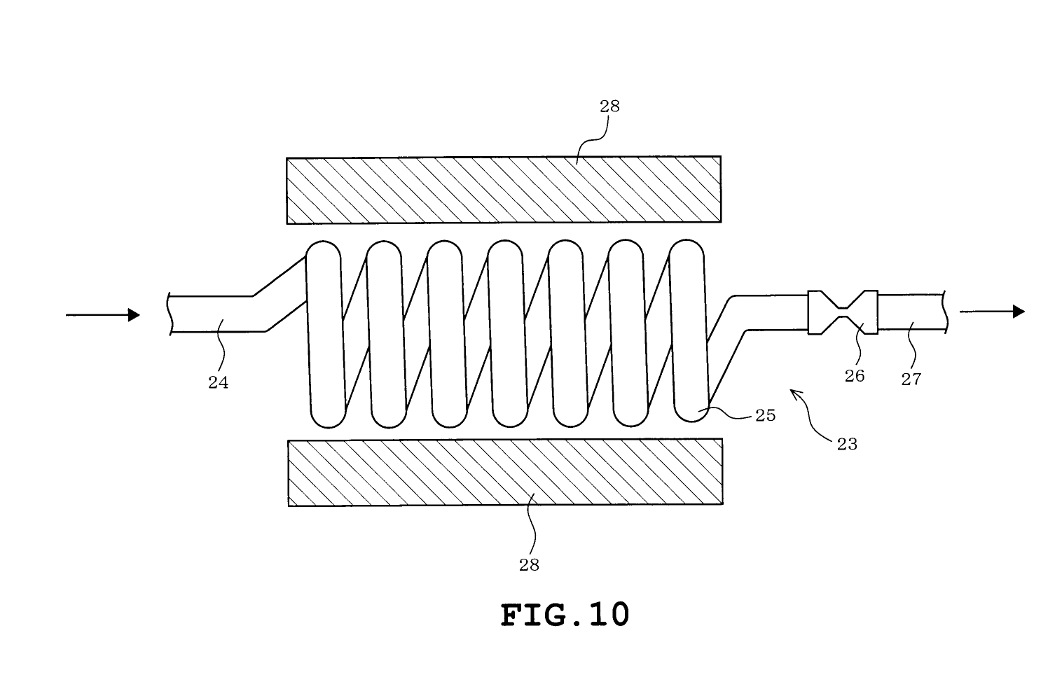

FIG. 10 illustrates an exemplary structure of vaporizer 23.

Vaporizer 23 is primarily configured by inlet 24, a heat exchanger, orifice 26, and outlet 27. The heat exchanger includes a spirally molded heat exchange tube 25 and lamp heater 28 surrounding heat exchange tube 25. Aqueous hydrogen peroxide solution is supplied to inlet 24 typically at the speed of 200[sccm] and then is passed through heat exchange tube 25. Heat exchange tube 25 is heated by the surrounding lamp heater 28 to thereby vaporize the aqueous hydrogen peroxide solution passing through it. Orifice 26 pressurizes the aqueous hydrogen peroxide solution as required to prevent bumping within the pipings due to depressurization. Hydrogen peroxide vapor is discharged as hot vapor or mist from outlet 27. Because the aqueous hydrogen peroxide solution is vaporized immediately before it is supplied into oxidation unit 17 through outlet 27, thermal decomposition can be minimized to allow efficient conversion of polymer film 3b into silicon oxide film.

Referring back to FIG. 9, hydrogen peroxide vapor generated by vaporizer 23 is injected from shower nozzle 29 substantially uniformly over the entire upper surface of substrate 3 placed on susceptor (holder) 30. Condensed liquid of the injected vapor and condensed liquid of purified steam are discharged from oxidation unit 17 through drain 20. Gas containing hydrogen peroxide is exhausted from acid exhaust duct 21. The foregoing structures formulate oxidation unit 17.

In a modified arrangement, 30 wt % aqueous hydrogen peroxide solution may be flow controlled by liquid MFC and be mixed with hot carrier gas at vaporizer 23 to generate vapor. The generated vapor may be sprayed over substrate 3 through a spray mechanism connecting with inlet 18. The carrier gas used in this case may be nitrogen or oxygen and blower mechanism for blowing purge gas onto substrate 3 may be further provided.

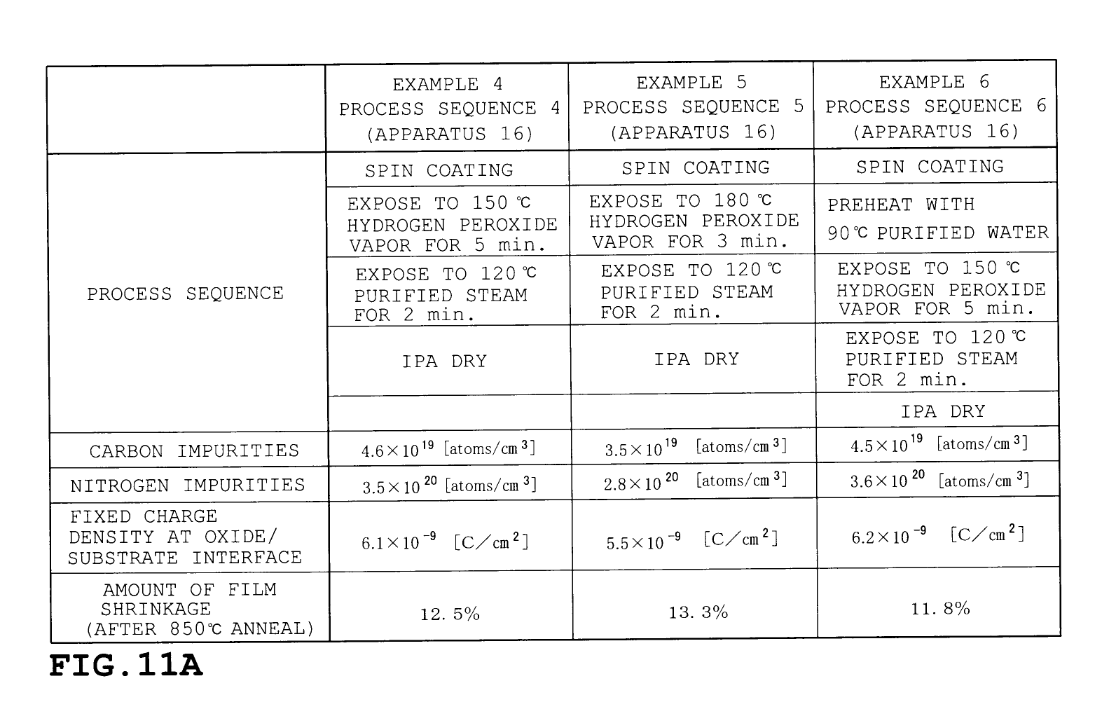

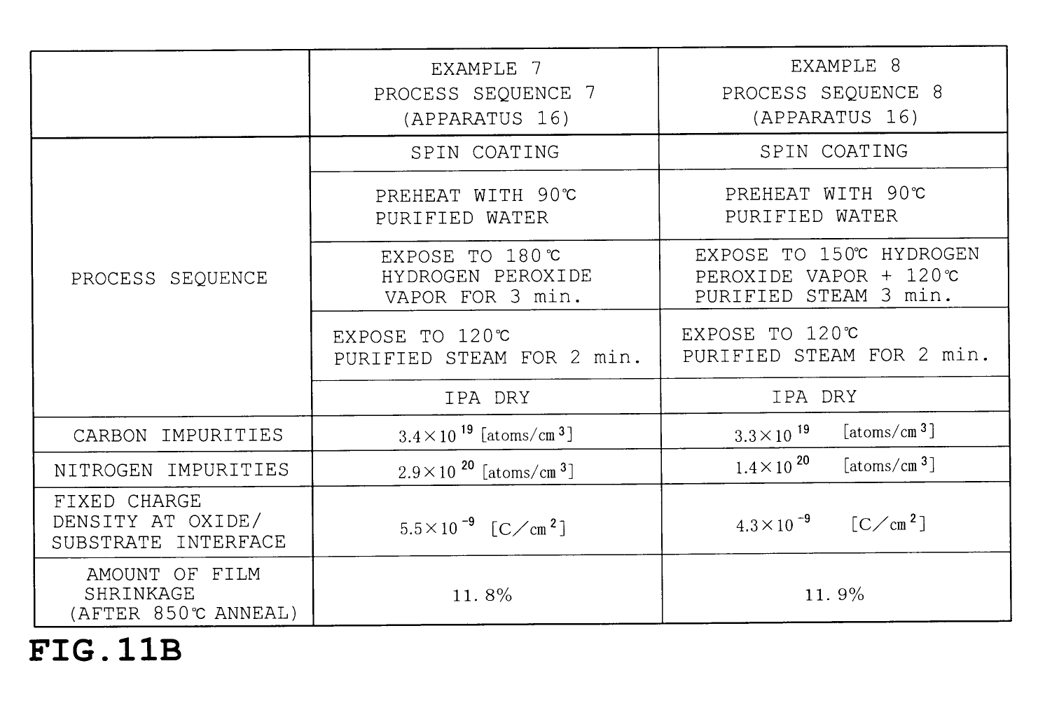

Oxidation performed by oxidation unit 17 will be discussed with reference to FIGS. 11A and 11B. The chart given in FIGS. 11A and 11B indicate the process sequences of EXAMPLES 4 to 8.

### Example 4

Polymer film 3b was formed above substrate 3 as discussed in EXAMPLE 1. Substrate 3 coated with polymer film 3b was placed on susceptor 30 in oxidation unit 17. Then, hydrogen peroxide vapor heated to 150 degrees Celsius was injected over substrate 3 through inlet 18, causing heatup of substrate 3 and reaction between polymer film 3b and hydrogen peroxide. After exposing substrate 3 to hydrogen peroxide vapor for a predetermined time period, in this case, 5 minutes, purified steam heated to 120 degrees Celsius was injected into oxidation unit 17 for 2 minutes from inlet 18 to rinse away the residual hydrogen peroxide.

The purified steam was flow controlled when in the liquid phase as done for aqueous hydrogen peroxide solution and was vaporized immediately before being injected into oxidation unit 17. Purified steam was supplied at the typical speed of 10 [slm]. Condensed liquid of the injected purified steam was discharged from oxidation unit 17 through drain 20. Then, supply of purified steam was stopped and check valve 20a of drain 20 was closed, followed by a supply of IPA vapor from inlet 19 to remove moisture from the surface of substrate 3. Finally, IPA vapor and moisture was discharged from vacuum exhaust duct 22 to dry substrate 3.

### Example 5

EXAMPLE 5 differs from EXAMPLE 4 in that the temperature of hydrogen peroxide vapor being injected over substrate 3 is elevated from 150 degrees Celsius to 180 degrees Celsius and the duration of exposure of substrate 3 to hydrogen peroxide vapor was shortened from 5 minutes to 3 minutes. The rest of the process sequence remains the same.

### Example 6

Unlike hydrogen peroxide, drainage of purified water does not affect the environment and thus is less restrictive in its amount of use as compared to hydrogen peroxide. EXAMPLE 6 and subsequent EXAMPLES 7 to 8 take advantage of this characteristic of purified water and utilize warm purified water for preheating substrate 3 after spin coating and before elevating the temperature of substrate 3 with hydrogen peroxide vapor to accelerate the temperature elevation of substrate 3. More specifically, the preheating was carried out by either immersing substrate 3 with warm purified water or injecting purified steam over substrate 3. The rest of the process sequence remains the same from EXAMPLE 4.

### Example 7

After spin coating and preheating, hydrogen peroxide vapor heated to the temperature of 180 degrees Celsius was injected over substrate 3 as done in EXAMPLE 5. After 3 minutes of exposure, substrate 3 was processed according to the remaining process sequence of EXAMPLE 4.

### Example 8

After spin coating and preheating, a mixture of 30 wt % of hydrogen peroxide vapor heated to 150 degrees Celsius and purified steam heated to 120 degrees Celsius was injected over substrate 3 instead of the exposure to hydrogen peroxide vapor of EXAMPLES 6 and 7. After 3 minutes of exposure, substrate 3 was processed according to the remaining process sequence of EXAMPLE 4.

FIGS. 11A and 11B taken together provide a comparative chart of the process sequences executed in EXAMPLES 4 to 8 and the features of the resulting film which are evaluated by (1) carbon impurity concentration, (2) nitrogen impurity concentration, (3) fixed charge density, and (4) amount of film shrinkage after thermal treatment executed in inert gas atmosphere at 850 degrees Celsius.

It was verified that by employing the process sequences of EXAMPLES 4 to 8, polymer film 3b was converted into silicon oxide film with reduced impurities. That is, it was verified that impurities such as carbon and hydrocarbon originating from the solvent can be reduced to a concentration below 10²⁰ [atoms/cc] while preventing their diffusion toward the interface between the resulting silicon oxide film and substrate 3, and nitrogen originating from perhydro-polysilazane polymer can be reduced to a concentration below 10²¹ [atoms/cc].

Advantageously, the results of EXAMPLES 4 to 8 generally show less impurity concentration, less film shrinkage, and less interfacial fixed charge density as compared to COMPARATIVE EXAMPLES 1 and 2 and further in comparison with EXAMPLES 1 to 3 of the first exemplary embodiment. Of note is that, EXAMPLES 1 to 3 of the first exemplary embodiment, show less film shrinkage as compared to EXAMPLES 4 and 5. This may be explained by: (a) the rapid temperature elevation of substrate 3 in EXAMPLES 4 and 5; and (b) less amount of aqueous hydrogen peroxide solution being used when substrate 3 is exposed to hydrogen peroxide vapor as compared to when substrate 3 is immersed with aqueous hydrogen peroxide solution. To elaborate on (a), hydrogen peroxide in gaseous state is supplied into oxidation unit 6 for reaction with polymer film 3b in EXAMPLES 4 and 5, whereas hydrogen peroxide is provided in a liquid state in EXAMPLES 1 to 3, with the former being typically higher in temperature than the latter. Thus, (a) and (b) taken together may have caused temperature elevation to progress at a relatively faster pace than progression of oxidation in EXAMPLES 4 and 5 as compared to EXAMPLES 1 and 3 to possibly cause evaporation of some of the low-molecular weight components from polymer film 3b.

As for the impurity concentration of the resulting silicon oxide film, EXAMPLES 4 to 8 of the third exemplary embodiment indicate lower figures as compared to EXAMPLES 1 to 3 of the first exemplary embodiment. This is an indication that exposure to hydrogen peroxide containing vapor allows more efficient oxidation and impurity removal as compared to the immersion to aqueous hydrogen peroxide solution.

As evidenced in the results of EXAMPLES 6 and 7, preheating of polymer film 3b by warm purified water causes oxidation reaction of the polymer components with the warm purified water and thereby prevent sublimation of low-molecular weight polymer components as well as accelerating the heating of substrate 3. Though the 30 wt % of hydrogen peroxide vapor originally contains steam, further mixture with hot steam provides even greater decrease in impurities, especially to nitrogen impurities.

Perhydro-polysilazane polymer, hydrogen peroxide, and carbon impurities within the polymer film cause the reactions represented by the following chemical formulae. As shown, Si—H bond contained in perhydro-polysilzane polymer is converted into Si—O bond.

(—SiH₂NH—)+2H₂O₂→(—OSiNH—)+3H₂O (1)

C+2H₂O₂→CO₂(g)↑+2H₂O (2)

Perhydro-polysilazane polymer and water causes the reaction represented by the following chemical formula. As shown, Si—N bond contained in perhydro-polysilzane polymer is converted into Si—O bond.

(—SiH₂NH—)+H₂O→(—SiH₂O—)+NH₃(g)↑ (3)

Thus, hydrogen peroxide serving as a source of active oxygen reacts with carbon (C) and Si—H bond, whereas water primarily reacts with Si—N bond. Thus, both hydrogen peroxide and water may be supplied in order to efficiently convert perhydro-polysilazane polymer film 3b containing carbon impurities and nitrogen impurities into a silicon oxide film.

As was the case in the first exemplary embodiment, apparatus 16 allows the sequence of polymer film 3b spin coating to polymer-to-silicon oxide film conversion to be executed consecutively within a single apparatus without contacting the surface of substrate 3 that is covered with polymer film 3b in any one of the process sequences set out in EXAMPLES 4 to 8 of the third exemplary embodiment. This means that the number of apparatuses used and the number of process steps required can be reduced as compared to comparative EXAMPLES 1 and 2.

Apparatus 16 further allows a high-quality silicon oxide film with outstanding gap-fill capability to be obtained under relatively low process temperature while almost completely eliminating sublimation of low-molecular weight polysilazane polymer components, thereby yielding a high-performance electronic device.

More specifically, apparatus 16 for forming a silicon oxide film according to the third exemplary embodiment is provided with oxidation unit 17 that converts polymer film 3b into silicon oxide film by supplying hydrogen peroxide vapor controlled within a temperature level ranging between 100 degrees Celsius and 200 degrees Celsius.

By promoting reaction between polymer film 3b and hydrogen peroxide vapor for conversion into silicon oxide film at a temperature level of 200 degrees Celsius or less and typically at 150 degrees Celsius, low-molecular weight components stays within polymer film 3b without sublimation. Thus, a dense or less porous silicon oxide film can be formed to prevent film shrinkage with thermal budget in subsequent process steps.

Apparatus 16 carries out the process sequences including reaction of polymer film 3b and hydrogen peroxide vapor, draining hydrogen peroxide waste, rinsing, and drying within a single apparatus housing. Aqueous hydrogen peroxide solution, when sprayed, allows more efficient polymer-to-silicon oxide conversion with less chemical ingredients as well as more efficient removal of hydrogen peroxide and dry of substrate 3.

Further, waste water containing hydrogen peroxide residue is discharged from the drain mechanism exemplified as drain 20 during purified steam cleaning. This allows the safety mechanism of the wet clean feature to be utilized, thereby reducing the number of apparatuses as compared to the conventional process sequences as well as improving safety.

By generating a highly reactive hydrogen peroxide vapor from a stable aqueous hydrogen peroxide solution, decomposition of hydrogen peroxide can be minimized to allow effective conversion of polymer film 3b into silicon oxide film.

As indicated in EXAMPLE 8, polymer film 3b can be converted efficiently into silicon oxide film by exposing polymer film 3b to a reaction gas comprising a vaporized mixture of hydrogen peroxide vapor and steam. Thus, impurity concentration can be reduced as compared to executing the reaction with substrate 3 with hydrogen peroxide alone.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for forming silicon oxide film comprising:
a spin coating unit that forms a polymer film above a substrate by spin coating a solution comprising a polymer containing a silazane bond dissolved in an organic solvent;
an oxidation unit that converts the polymer film into a silicon oxide film; and
a carrying unit that carries the substrate having the polymer film formed thereabove by the spin coating unit to the oxidation unit without contacting the polymer film;
the oxidation unit, when receiving the substrate from the carrying unit, converts the polymer film into the silicon oxide film by either immersing the polymer film with a heated aqueous solution containing hydrogen peroxide, spraying the heated aqueous solution containing hydrogen peroxide over the polymer film, or exposing the polymer film to a reaction gas containing a hydrogen peroxide vapor, and
the apparatus, by itself, completes the formation of the polymer film by the spin coating unit and the conversion of the polymer film into the silicon oxide film by the oxidation unit within the apparatus itself.

2. The apparatus according to claim 1, wherein the oxidation unit oxidizes the polymer film by immersing the polymer film with the heated aqueous solution containing hydrogen peroxide, and
wherein the oxidation unit includes:
a holder that holds the substrate carried to the oxidation unit by the carrying unit,
a hydrogen peroxide supply mechanism that supplies the heated aqueous solution containing hydrogen peroxide to the substrate, and
a drain mechanism that discharges residual waste water from the oxidation unit.

3. The apparatus according to claim 1, wherein the oxidation unit further includes an inner wall coated with a fluorine based resin.

4. The apparatus according to claim 1, wherein the oxidation unit further includes an inner wall having a resin molded inner surface.

5. The apparatus according to claim 1, further comprising an isothermal plate, a temperature control mechanism, and a load port,
wherein the carrying unit further carries the substrate from the load port to the spin coating unit and
wherein the carrying unit, prior to carrying the substrate to the spin coating unit, places the substrate on the isothermal plate to maintain the substrate at a predetermined temperature through the temperature control mechanism.

6. The apparatus according to claim 1, wherein the carrying unit includes a base end, a plurality of arms branching laterally from the base end, and a plurality of support pins provided on an upper portion of the arms, the support pins supporting an underside bevel of the substrate.

7. The apparatus according to claim 1, wherein the carrying unit carries the substrate after the polymer film formed above the substrate by the spin coating unit is removed from a perimeter edge of the substrate.

8. The apparatus according to claim 2, wherein the spin coating unit forms the polymer film by dropping a polymer solution comprising a perhydro-polysilazane polymer dissolved in the organic solvent over a substantial center of a spinning substrate, and
wherein the oxidation unit converts the polymer film into the silicon oxide film by:
immersing the substrate for a predetermined time period with a heated aqueous hydrogen peroxide solution supplied into the oxidation unit,
substituting the heated aqueous hydrogen peroxide solution within the oxidation unit with purified water, and
drying the substrate by supplying hot nitrogen into the oxidation unit.

9. The apparatus according to claim 2, wherein the spin coating unit forms the polymer film by dropping a polymer solution comprising a perhydro-polysilazane polymer dissolved in the organic solvent over a substantial center of a spinning substrate, and
wherein the oxidation unit converts the polymer film into the silicon oxide film by:
immersing the substrate for a predetermined time period with a heated aqueous hydrogen peroxide solution supplied into the oxidation unit,
substituting the heated aqueous hydrogen peroxide solution within the oxidation unit with purified water, and
drying the substrate by isopropyl alcohol.

10. The apparatus according to claim 2, wherein the spin coating unit forms the polymer film by dropping a polymer solution comprising a perhydro-polysilazane polymer dissolved in the organic solvent over a substantial center of a spinning substrate, and
wherein the oxidation unit converts the polymer film into the silicon oxide film by:
immersing the substrate for a predetermined time period with a heated aqueous hydrogen peroxide solution supplied into the oxidation unit,
cleaning the heated aqueous hydrogen peroxide solution within the oxidation unit with purified steam, and
drying the substrate.

11. The apparatus according to claim 1, wherein the oxidation unit oxidizes the polymer film by spraying the heated aqueous solution containing hydrogen peroxide over the substrate, the heated aqueous solution containing hydrogen peroxide being atomized before being sprayed over the substrate.

12. The apparatus according to claim 11, wherein the oxidation unit includes:
a holder that holds the substrate carried to the oxidation unit by the carrying unit,
a spray mechanism that sprays the heated aqueous solution containing hydrogen peroxide over the substrate after being atomized by a carrier gas, and
a drain mechanism that discharges residual waste water from the oxidation unit.

13. The apparatus according to claim 1, wherein the carrying unit includes: a base end, a plurality of arms that extend from the base end and along an outer perimeter surface of the substrate, and a plurality of support sections protruding radially inward from inner perimeter surfaces of the arms, the support sections supporting an underside bevel of the substrate.

14. The apparatus according to claim 1, wherein the oxidation unit oxidizes the polymer film by exposing the polymer film to the reaction gas containing the hydrogen peroxide vapor, and
wherein the oxidation unit includes:
a holder that holds the substrate carried to the oxidation unit by the carrying unit,
a spray mechanism that sprays the hydrogen peroxide vapor over the substrate, and
a drain mechanism that discharges residual waste water from the oxidation unit.

15. The apparatus according to claim 14, wherein the oxidation unit further includes a generator that generates the hydrogen peroxide vapor by either thermally vaporizing an aqueous hydrogen peroxide solution with a heat exchange element or thermally vaporizing the aqueous hydrogen peroxide solution through mixture with a heated carrier gas,
the spray mechanism being configured to spray the hydrogen peroxide vapor generated by the generator over the substrate.

16. The apparatus according to claim 15, wherein the heat exchange element of the generator includes a spirally molded heat exchange tube and a lamp heater disposed around the heat exchange tube,
the generator, when thermally vaporizing the aqueous hydrogen peroxide solution with the heat exchange element, vaporizes the aqueous hydrogen peroxide solution by heating the aqueous hydrogen peroxide solution passing through the heat exchange tube with the lamp heater.

17. The apparatus according to claim 14, wherein the spin coating unit forms the polymer film by dropping a polymer solution comprising a perhydro-polysilazane polymer dissolved in the organic solvent over a substantial center of a spinning substrate, and
wherein the oxidation unit converts the polymer film into the silicon oxide film by:
injecting the hydrogen peroxide vapor into the oxidation unit,
exposing the substrate to the injected hydrogen peroxide vapor for a predetermined time period,
cleaning away hydrogen peroxide within the oxidation unit by injecting purified steam, and
drying the substrate.

18. The apparatus according to claim 17, wherein the oxidation unit preheats the substrate prior to injecting the hydrogen peroxide vapor by either immersing the substrate with warm purified water or injecting purified steam over the substrate.

19. The apparatus according to claim 14, wherein the spin coating unit forms the polymer film by dropping a polymer solution comprising a perhydro-polysilazane polymer dissolved in the organic solvent over a substantial center of a spinning substrate, and
wherein the oxidation unit converts the polymer film into the silicon oxide film by:
injecting a mixture of the hydrogen peroxide vapor and purified steam into the oxidation unit,
exposing the substrate to the injected mixture for a predetermined time period,
cleaning away hydrogen peroxide within the oxidation unit by injecting purified steam, and
drying the substrate.

20. The apparatus according to claim 19, wherein the oxidation unit preheats the substrate prior to injecting the mixture by either immersing the substrate with warm purified water or injecting purified steam over the substrate.
